(19) United States
(12) Patent Application Publication
(10) Pub. No.: US 2021/0021620 A1
(43) Pub. Date: Jan. 21, 2021

(54) UPDATING REGULAR EXPRESSION PATTERN SET IN TERNARY CONTENT-ADDRESSABLE MEMORY

(71) Applicant: HEWLETT PACKARD ENTERPRISE DEVELOPMENT LP, Houston, TX (US)

(72) Inventors: Catherine Graves, Milpitas, CA (US); John Paul Strachan, Milpitas, CA (US)

(21) Appl. No.: 17/042,778

(22) PCT Filed: Apr. 30, 2018
(86) PCT No.: PCT/US2018/030078

§ 371 Date: Sep. 28, 2020

(51) Int. Cl. H04L 29/06

(52) U.S. Cl. CPC H04L 63/1416

(57) ABSTRACT

A secondary ternary content-addressable memory (TCAM) is programmed with a new regular expression to be added to a regular expression pattern set. Incoming data strings are processed against a primary TCAM programmed with the regular expression pattern set and against the secondary TCAM in parallel.

While the incoming data strings are processed against the primary TCAM and against the secondary TCAM in parallel, the regular expression pattern set is updated to add the new regular expression.

### GOVERNMENT LICENSE RIGHTS

This invention was made with US government support under contract 2017-17013000002, awarded by the Intelligence Advanced Research Projects Activity (AIRPA). The government has certain rights in the invention.

### BACKGROUND

With the advent of the Internet, computing devices with networking capability are potentially able to communicate with nearly any other computing device that is also connected to the Internet. Such ubiquitous communication capabilities have opened up usage scenarios and opportunities that were nearly unimaginable prior to the Internet. However, the Internet has proven to have drawbacks as well: nefarious users are now more easily able to penetrate local networks and access the computing devices connected to such networks, to both access the data stored on the computing devices and use the devices for their own malevolent purposes.

### BRIEF DESCRIPTION OF THE DRAWINGS

FIG. 1 is a diagram depicting an example as to how a secondary ternary content-addressable memory (TCAM) programmed with a new regular expression can be used with a primary TCAM programmed with a regular expression pattern set for processing an input string.

FIG. 2 is a flowchart of an example method as to how a secondary TCAM programmed with a new regular expression can be used with a primary TCAM programmed with a regular expression pattern set for processing an input string.

FIG. 3 is a diagram depicting another example as to how a secondary TCAM programmed with a new regular expression can be used with a primary TCAM programmed with a regular expression pattern set for processing an input string.

FIG. 4 is a flowchart of another example method a secondary TCAM programmed with a new regular expression can be used with a primary

TCAM programmed with a regular expression pattern set for processing an input string.

FIG. 5 is a flowchart of an example method for programming a TCAM with a regular expression.

FIG. 6 is a flowchart of an example method for programming a

TCAM with a regular expression pattern set updated with a new regular expression.

FIG. 7 is a diagram of an example system for filtering input strings using a regular expression-matching filtering technique, via TCAMs.

### DETAILED DESCRIPTION

As noted in the background section, with the increasing interconnectedness of computing devices on a global scale has come the potential for computing devices to have their data and the control of the devices themselves compromised. In enterprise and other environments, computing devices like desktop and laptop computers, among other types of computing devices, are commonly connected to a local area network, which itself is connected to outside networks like the Internet via one or more managed points of access. These managed points of access can be responsible for ensuring the safety of data passing through them, before the data arrives at their intended destination computing devices on the network.

One way to accomplish such network security is to filter incoming (and potentially outgoing) data for known security threats, including malware, viruses, network attacks, and other types of security threats. Strings of data are thus compared to security threat signatures. If a data string of a data packet does not match an existing threat signature, then the packet may be permitted to pass (i.e., enter the local network, or leave the local network). If the data string does match an existing threat signature, its data packet can be tagged as an actual or potential security threat and its passage at least temporarily prevented.

If tagged as a potential security threat, the data packet may undergo further scrutiny to determine if the packet indeed poses a threat. For instance, in network intrusion detection systems, such a packet may be tagged as a potential security threat but still permitted to pass, whereas in network intrusion prevention systems, such a packet may be tagged as a potential security threat and also immediately blocked.

One type of filtering technique that can be employed as a network security filtering technique uses regular expression matching. A regular expression, or regex or regexp, is a sequence of characters that defines a pattern. Each character in a regular expression is a metacharacter having a special meaning, or a regular character that has a literal meaning. The existing threat signatures are therefore reduced to a set of regular expression patterns, and incoming data strings processed against this set to determine whether they are potential network security threats or not.

To quickly filter incoming data strings, a type of memory known as a ternary content addressable memory (TCAM) can be employed to provide for massively parallel searching of an incoming data string against a set of regular expression patterns. In typical, non-CAM computer memory, such as random-access memory (RAM), the contents or data stored in the memory are looked up by memory address. By comparison, within a CAM, the memory is content addressable. To search the CAM, content is provided, instead of a memory address. A CAM is usually a binary CAM, which can just match binary values, such as logic zero and logic one. By comparison, a TCAM can match values based on three inputs: logic zero, logic one, and a don't care state.

A TCAM is thus programmed in accordance with a set of regular expression patterns. More specifically, a TCAM can be programmed with a compressed finite automata (CFA) for this set of regular expression patterns. An FA is a type of data structure that is conducive to being programmed into a TCAM, and results in the TCAM being amenable to usage in massively parallel searching. An FA is a finite state machine that can be in exactly one of a finite number of states at any given time, and which changes from one state to another along a transition. Generating a CFA to represent a large set of regular expression patterns can take on the order of many hours.

The set of known security threat signatures in the context of network security applications is not static, however. New security threat signatures are regularly discovered, and thus have to be added to the set. A new, updated CFA may be generated, which means that during the hours it takes to regenerate the CFA, incoming strings of data are not being processed against the new security threat signatures. Research has focused on updating the CFA so that it does not have to be regenerated from scratch, but such updating processes are difficult to implement, and still take time to occur.

Techniques described herein, by comparison, employ at least two TCAMs: a primary TCAM programmed with a regular expression pattern set, and a secondary TCAM programmed with a new regular expression that is to be added to this set. Incoming data strings are processed against both TCAMs in parallel. While this processing is occurring, the regular expression pattern set is updated with the new regular expression. Once the expression pattern set has been updated, incoming data string processing may momentarily pause to permit the primary TCAM to be programmed with the updated set. In a different implementation, another primary TCAM may be programmed with the updated set, and switched in for the primary TCAM that is programmed with the non-updated regular expression pattern set.

Therefore, during the potentially lengthy time to update the regular expression pattern set to add the new regular expression, incoming data strings are still nevertheless processed against this expression in addition to the expression pattern set. Programming a TCAM that is implemented with memristors in particular according to a new regular expression may take less than half of a millisecond, for instance. This length of time is sufficiently short that incoming data string processing may be temporarily paused with minimal effect on throughput, or if pausing does not occur, the length of time is sufficiently short that relatively few incoming data strings are not processed against the new regular expression. Furthermore, using a memristor-implemented TCAM for the primary TCAM provides for sufficient power overhead that permits a CFA of a large complex regular expression set to be used, from a practical efficiency standpoint.

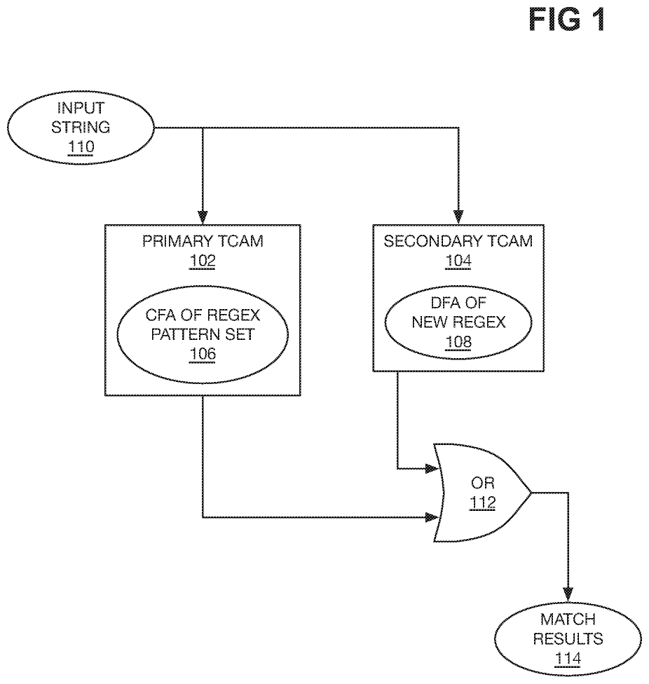

FIG. 1 shows an example as to how a primary TCAM 102 can be used in conjunction with a secondary TCAM 104 to process input strings 110, which are each a series of one or more characters. The primary TCAM 102 is programmed with a CFA 106 of a regular expression pattern set. The secondary TCAM 104 is programmed with a deterministic FA (DFA) 108 of a new regular expression.

Each input string 110 is tested against the primary TCAM 102 and the secondary TCAM 104 in parallel. The primary TCAM 102 outputs whether the input string 110 in question matches any regular expression within the regular expression pattern set of the CFA 106 programmed in the TCAM 102. The secondary TCAM 104 outputs whether the input string matches the new regular expression of the DFA 108 programmed in the TCAM 104.

The outputs of the TCAMs 102 and 104 can be logically ORed. Logical ORing of the outputs of the TCAMs 102 and 104 is indicated by a logical OR operator 112, to yield match results 114. Therefore, the match results 114—i.e., the output of the logical OR operator 112—are positive if an input string 110 matches any regular expression of the regular expression pattern set of the CFA 106 of the primary TCAM 102, and/or the new regular expression of the DFA 108 of the secondary TCAM 104.

In operation, then, when a new regular expression is identified against which input strings are to be processed, the CFA 106 of the new regular expression pattern set does not have to be updated in real time or near-real time to permit testing of input strings against this new regular expression. Rather, the secondary TCAM 104 can be quickly programmed with a DFA 108 of the new regular expression. Subsequent input string processing thus occurs as to both the TCAMs 102 and 104 in parallel.

In the background, the regular expression pattern set may be updated with the new regular expression, and a CFA of the updated regular expression pattern set generated. As noted above, this process can take hours. Once the new CFA is ready, and has been programmed into the primary TCAM 102 (or a different primary TCAM, as described in detail below), subsequent input string processing can occur just as to the primary TCAM in question, and not in relation to the secondary TCAM 104. The secondary TCAM 104 is no longer needed, since its regular expression is now reflected within the primary TCAM 102.

A CFA of the updated regular expression pattern set is employed instead of just a DFA of the pattern set, because CFAs are significantly more power and area efficient over DFAs, by orders of magnitude. As such, performing regular expression matching with DFAs can be infeasible from a power and area standpoint for larger pattern sets. Furthermore, as noted above, having the primary TCAM 102 be a memristor-implemented TCAM provides for sufficient power overhead that permits a CFA of a large complex regular expression set to used from a practical efficiency perspective. One example of a memristor-implemented TCAM is described in L. Huang et al., “ReRAM-based 4T2R non-volatile TCAM with a 7× NVM-stress reduction, and 4× improvement in speed word length-capacity for normally-off instant-on filter-based search engines used in big-data processing,” VLSI Symposium, June 2014, pp. 99-100. Another example is described in M. Chang et al., “A 3T1R non-volatile TCAM using MLC ReRAM with sub-1ns search time,” 2015 IEEE International Solid-State Circuits Conference, 2015, pp. 1-3.

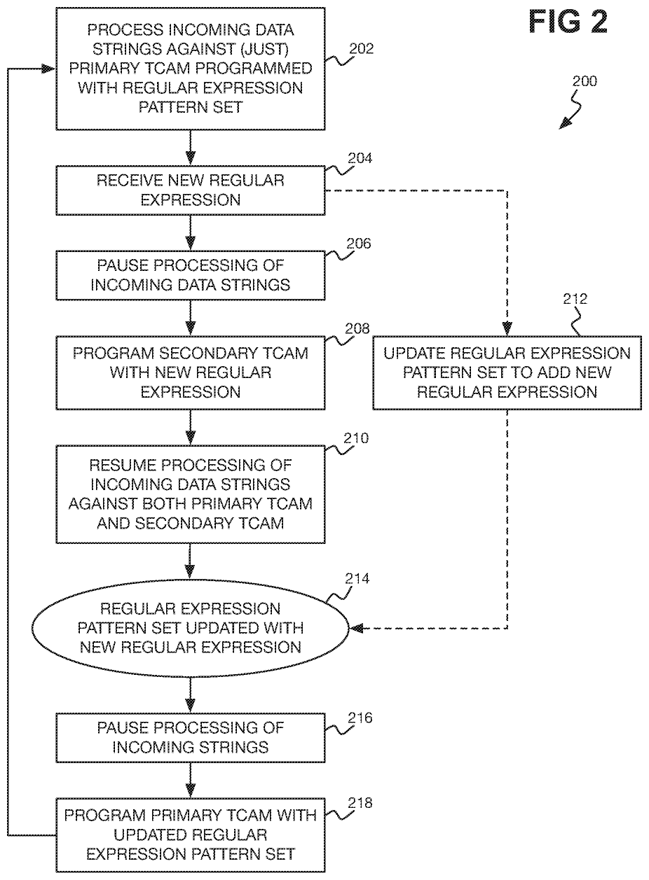

FIG. 2 shows an example method 200 for processing incoming data strings against both the primary TCAM 102 and the secondary TCAM 104 after a new regular expression has been received, until the primary TCAM 102 has been programmed with an updated regular expression pattern set that includes the new regular expression. The method 200 may be implemented as program code executable by a processor of a computing device that also includes the TCAMs 102 and 104. The program code can be stored on a non-transitory computer-readable data storage medium.

Incoming data strings are at first processed against just the primary TCAM 102 programmed with the CFA 106 of a regular expression pattern set (202). While such processing occurs, a new regular expression is received (204). In one implementation, processing of the incoming data strings is paused (206), while the secondary TCAM 104 is programmed with the DFA 108 of the new regular expression (208). Processing of incoming data strings then resumes against both the primary TCAM 302 and the secondary TCAM 104 (210).

In another implementation, incoming data string processing may not be paused in part 206, which means that after the new regular expression has been received in part 204 and prior to the secondary TCAM 104 having been programmed with the DFA 108 of the new regular expression, processing occurs just against the primary TCAM 102. As noted above, generation of the DFA 108 and subsequent programming of the secondary TCAM 104 can take less than half of a millisecond. Therefore, the number of data strings that are not processed after the new regular expression is received in part 204 but before the secondary TCAM has been programmed with the new regular expression in part 208 is small.

In parallel with processing of the incoming data strings against both the primary TCAM 102 and the secondary TCAM 104 (210), the regular expression pattern set of the CFA 106 in accordance with which the primary TCAM 102 has been programmed is updated to add the new regular expression received in part 204 (212). As noted above, updating the regular expression pattern set can take many hours. During this time, incoming data strings are nevertheless processed against the new regular expression (in addition to the existing regular expression pattern set), due to their being processed against the secondary TCAM 104 as well as against the primary TCAM 106.

In the implementation of FIG. 2, once the regular expression pattern set has been updated with the new regular expression (214), processing of incoming data strings is paused (216) so that the primary TCAM 102 can be programmed with the (new) CFA 106 reflecting the updated regular expression pattern set (218). The method 200 is then repeated at part 200. That is, processing of subsequently received incoming data strings occurs against just the primary TCAM 102 again (which is now programmed in accordance with the updated regular expression pattern set), and not against the secondary TCAM 104.

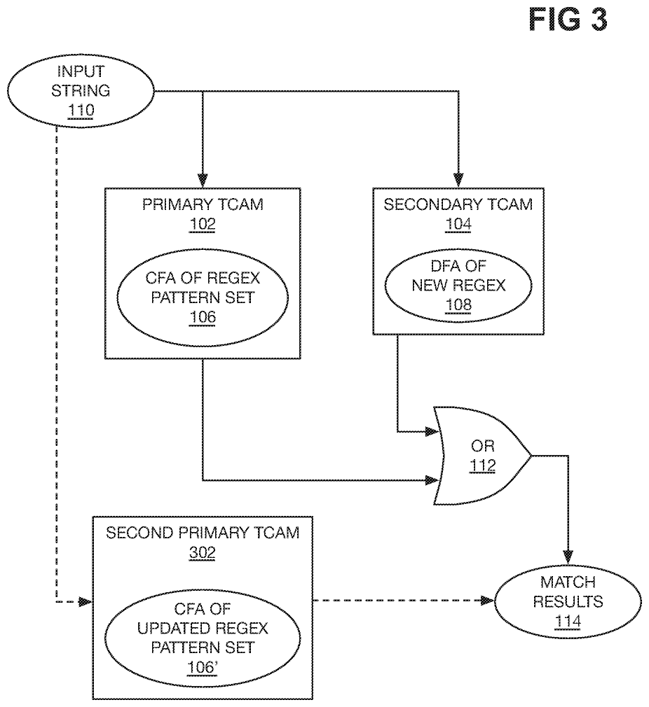

FIG. 3 shows an example as to how two primary TCAMs 102 and 302 can be used in conjunction with the secondary TCAM 104 to process the input strings 110. The primary TCAM 102 is referred to as a first primary TCAM 102 and the primary TCAM 302 is referred to as a second primary TCAM 302 to distinguish the TCAMs 102 and 302 from one another by name. As in FIG. 1, the first primary TCAM 102 is programmed with the CFA 106 of a regular expression pattern set, and the secondary TCAM 104 is programmed with the DFA 108 of a new regular expression.

Until the CFA 106 of the regular expression pattern set has been updated with the new regular expression, the operation of FIG. 3 is similar to that of FIG. 1. As such, the input strings 110 are tested against both the first primary TCAM 102 and the secondary TCAM 104 in parallel. The outputs of the TCAMs 102 and 104 can be logically ORed to yield the match results 104, which indicate whether an input string 110 matches any regular expression of the regular expression pattern set of the CFA 106 of the first primary TCAM 102, and/or the new regular expression of the DFA 108 of the secondary TCAM 104.

However, in FIG. 1, as described in relation to the method 200 of FIG. 2, once a new CFA of the regular expression pattern set as updated with the new regular expression has been generated, the primary TCAM 102 is programmed with the new CFA. Therefore, incoming data string processing is temporarily paused while the primary TCAM 102 is reprogrammed, before data string processing is resumed as to just the TCAM 102 itself. Throughput may temporarily suffer due to this temporary pausing.

By comparison, in the example of FIG. 3, instead of having to pause incoming data string processing so that the first primary TCAM 102 can be reprogrammed with the new CFA of the updated regular, a different, second primary TCAM 302 is instead programmed with the new CFA 106′ of the updated regular expression pattern set. Once such programming is complete, incoming data string processing then subsequently occurs against just the secondary primary TCAM 302, instead of against just the first primary TCAM 102. This subsequent processing is indicated in FIG. 3 via dashed lines, instead of the solid lines that indicating the parallel processing against the TCAMs 102 and 104. A decrease in incoming data string processing throughput is minimized, because such processing does not have to wait for programming a TCAM with a CFA.

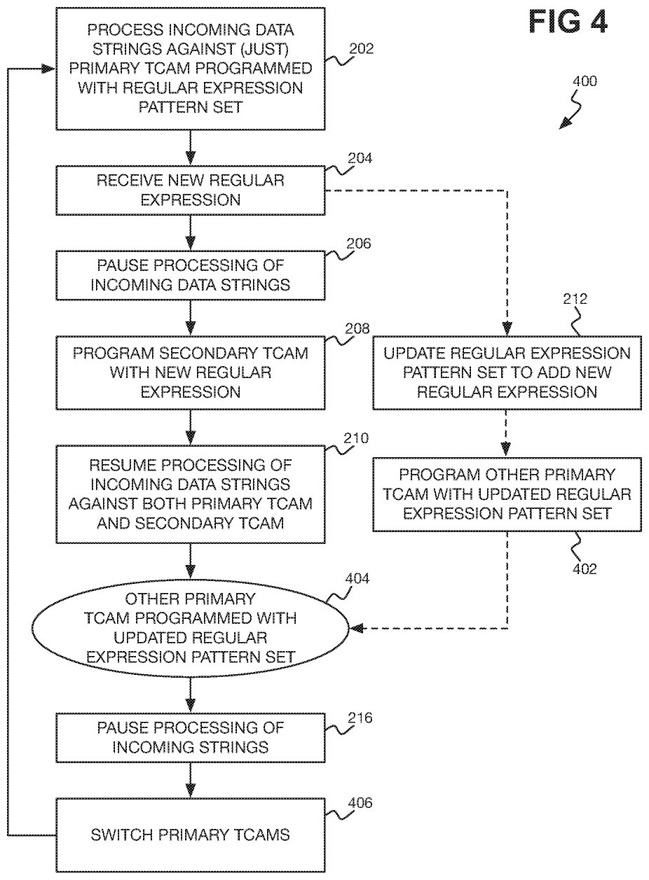

FIG. 4 shows an example method 400 for processing incoming data strings against both the first primary TCAM 102 and the secondary TCAM 104 after a new regular expression has been received, until the second primary TCAM 302 has been programmed with an updated regular expression pattern set that includes the new regular expression. Similar to the method 200, the method 400 may be implemented as program code executable by a processor of a computing device that also includes the TCAMs 102, 104, and 302. The program code can be stored on a non-transitory computer-readable data storage medium.

As in the method 200, incoming data strings are at first processed against just the first primary TCAM 102 programmed with the CFA 106 of a regular expression pattern set (202). While such processing occurs, a new regular expression is received (204). Processing of the incoming data strings may be paused (206) in one implementation (and not paused in another implementation), while the secondary TCAM 104 is programmed with the DFA 108 of the new regular expression (208). Processing of the incoming data strings then occurs against both the first primary TCAM 102 and the secondary TCAM 104.

In parallel with processing of the incoming data strings against both the primary TCAM 102 and the secondary TCAM 104 (210), the regular expression pattern set of the CFA 106 in accordance with which the first primary TCAM 102 has been programmed is updated to add the new regular expression received in part 204 (212). However, unlike in the method 200, the second primary TCAM 302 is programmed with the (new) CFA 106′ that reflects the updated regular expression pattern set (202), instead of the first primary TCAM 102 being so programmed. While this programming occurs, in other words, the first primary TCAM 102 and the secondary TCAM 104 continue to have incoming data strings processed against them.

Once the second primary TCAM 302 has been programmed the new CFA 106′ of the updated regular expression pattern set (404), it is just then that the processing of incoming strings against the first primary TCAM 102 and the secondary TCAM 104 is paused (216). At this time, the primary TCAMs 102 and 302 are effectively switched (406). As such, when the method 200 is repeated at part 202, processing of subsequently received incoming data strings is resumed against just the second primary TCAM 302, and not against the first primary TCAM 102 and the secondary TCAM 104.

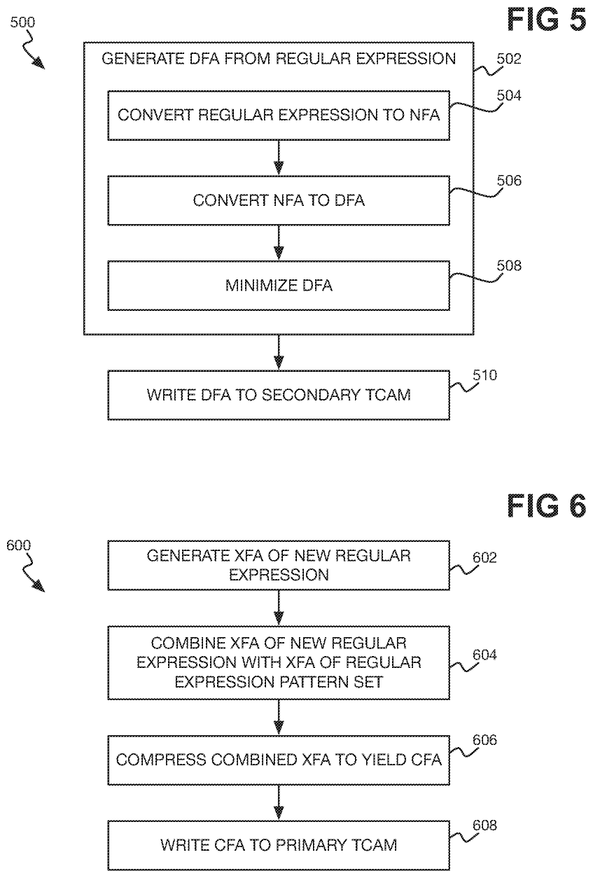

FIG. 5 shows an example method 500 for programming the secondary TCAM 104 with a (new) regular expression, and as such can implement part 208 of the methods 200 and 400 that have been described. Like the methods 200 and 400, the method 500 can be implemented as program code that a processor of a computing device that can also include the secondary TCAM 104 executes. The program code may be stored on a non-transitory computer-readable data storage medium.

A DFA is generated from the regular expression (502). This can be achieved by first converting the regular expression to a non-deterministic finite automata (NFA) (504), such as by using Thompson's algorithm. The NFA can then be converted to a DFA (506), such as by using a powerset algorithm, including the Rabin-Scott powerset technique. Finally, the resulting DFA may be minimized (508), such as by using Hoperoft's algorithm, and the minimized DFA written to the secondary TCAM 104 (510).

FIG. 6 shows an example method 600 for programming a primary TCAM, such as the first primary TCAM 102 or the second primary TCAM 302, with an updated regular expression pattern set. As such, the method 600 can implement parts 212 and 214 of the method 200 and parts 212 and 402 of the method 400 that have been described. Like the methods 200, 400, and 500, the method 600 can be implemented as program code that a processor of a computing device that can also include the primary TCAM 102 and/or the primary TCAM 302 executes. The program code may be stored on a non-transitory computer-readable data storage medium.

An extended finite automata (XFA) is generated from the new regular expression to be added to the existing regular expression pattern set (602). An XFA can be considered a finite automata that is augmented with memory to alleviate state space explosion that can occur with DFAs. Examples of techniques that can be used to generate an XFA include those described in the technical reference R. Smith et al., “XFA: Faster signature matching with extended automata,” published in IEEE Symposium on Security and Privacy (2008).

The XFA of the new regular expression can then be combined with an existing XFA of the regular expression pattern set (604). The resulting combined XFA can then be compressed to yield a CFA representing the regular expression pattern set as updated with the new regular expression (606). Examples of such combination and compression techniques include those described in the technical reference U. Pisolkar, “A survey on deterministic finite automata compression techniques,” published in the International Journal of Advanced Research in Computer Engineering & Technology (2015).

The CFA is finally written to the primary TCAM 102 or the primary TCAM 302 (608). The CFA can utilize the ternary characteristic of the primary TCAM 102 to combine rows of a state transition table to reduce the amount of memory needed to store the CFA in the TCAM. As an example, if two rows within the table differ by just one bit, then they can be combined into one row with the bit in question replaced with a ‘don't care’ state.

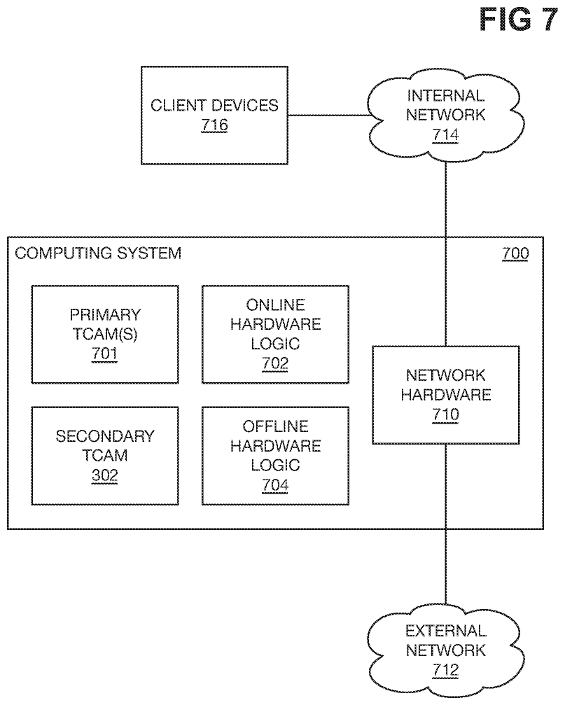

FIG. 7 shows an example system 700 for filtering filter queries. The system 700 may be implemented as one or more computing devices, for instance, such as servers. The system 700 includes one or more primary TCAMs 701, which can include the primary TCAMs 102 and/or 302 that have been described.

The primary TCAMs 701 can be implemented via memristors. The system 700 also includes the secondary TCAM 104 that has been described, which can similarly be implemented via memristors, or via static random-access memory (SRAM).

The system 700 can include both online hardware logic 702 and offline hardware logic 704. The online hardware logic 702 can process input strings against the TCAMs 701 and/or 302, as described in relation to FIGS. 2 and 4. The offline hardware logic 704 can update a regular expression pattern set with a new regular expression and may further program one of the primary TCAMs 701 with the updated regular expression pattern set, as also described in relation to FIGS. 2 and 4. The offline hardware logic 704 may also program the secondary TCAM 104 with the new regular expression as has been described.

The online hardware logic 702 can thus be considered online in that the logic 702 may have to perform its functionality in real time or near-real time. By comparison, the offline hardware logic 704 may be considered offline in that the logic 704 may not have to perform its functionality in real time or near-real time. Each of the online hardware logic 702 and the offline hardware logic 704 can be implemented as a processor and a non-transitory computer-readable data storage medium that stores code executable by the processor. Either of each of the online hardware logic 702 and the offline hardware logic 704 can instead be implemented as an application-specific integrated circuit (ASIC), or other specialized hardware.

FIG. 7 shows the specific case in which the computing system 700 can be used for network security purposes. As such, the computing system 700 includes network hardware 710, such as one or more network adapters, which communicatively connects the system 700 to both an external network 712 and an internal network 714. The external network 712 may be or include the Internet, for instance, whereas the internal network 714 may be local network like an intranet and/or a local-area network (LAN). Client computing devices 716 can also be connected to the internal network 714, such that the client computing devices 716 communicatively reach the external network 712 through the computing system 700.

Therefore, when a data packet arrives at the computing system 700 from over the external network 712, the computing system 700 may divide the packet, or at least its payload, into input strings, which are each processed against one of the TCAMs 701 in accordance with part 202 or 210 of FIGS. 2 and 4. If part 202 is currently being performed, then each input string is also processed against the secondary TCAM 104. Based on the results of this processing, the computing system 700 permits the data packet to pass through to the internal network 714 and to its destination client computing device 716 on the internal network 714, or prohibits the data packet from passing through.

In the former case, the system 700 identifies the data packet as not containing any input string that potentially corresponds to a security threat, due to no input string thereof matching the TCAMs 701 and/or the TCAM 302. In the latter case, the system 700 thus identifies the data packet as containing an input string that potentially corresponds to a security threat, due to an input string thereof matching one of the TCAMs 701 and/or the TCAM 302. The data packet may be quarantined for further analysis to confirm whether or not the packet represents a network security threat. Filtering of outgoing data packets can be inspected in the same way as incoming data packets.

The techniques that have been described herein use a secondary TCAM to permit incoming data strings to almost immediately be tested against a new regular expression while an existing regular expression pattern set of a primary TCAM is being updated. The techniques described herein can be used in the context of network security, to identify incoming input strings as potential security threats. In this and other contexts, accuracy and performance are improved, since new regular expressions can be tested against sooner than before.

We claim:

1. A method comprising:
programming a secondary ternary content-addressable memory (TCAM) with a new regular expression to be added to a regular expression pattern set;
processing incoming data strings against a primary TCAM programmed with the regular expression pattern set and against the secondary TCAM in parallel; and
while processing the incoming data strings against the primary TCAM and against the secondary TCAM in parallel, updating the regular expression pattern set to add the new regular expression.

2. The method of claim 1, further comprising, after the regular expression pattern set has been updated to add the new regular expression:
programming the primary TCAM with the updated regular expression pattern set; and
processing subsequently received incoming data strings against just the primary TCAM programmed with the updated regular expression pattern set and not against the secondary TCAM.

3. The method of claim 1, wherein the primary TCAM is a first primary TCAM, and the method further comprises, after full regular expression pattern set has been updated to add the new regular expression:
programming the second primary TCAM with the updated regular expression pattern set;
processing subsequently received incoming data strings against just the second primary TCAM programmed with the updated regular expression pattern set and not against the first primary TCAM or against the secondary TCAM.

4. The method of claim 1, wherein programming the secondary TCAM with the new regular expression comprises:
generating a deterministic finite automata (DFA) from the regular expression; and
writing the DFA to the secondary TCAM.

5. The method of claim 4, wherein generating the DFA from the regular expression comprises:
converting the regular expression to a non-deterministic finite automata (NFA);
converting the NFA to the DFA; and
minimizing the DFA.

6. The method of claim 5, wherein converting the regular expression to the NFA comprises using Thompson's algorithm,
wherein converting the NFA to the DFA comprises using a powerset algorithm,
and wherein minimizing the NFA comprises using Hoperoft's algorithm.

7. The method of claim 1, wherein updating the regular expression pattern set to add the new regular expression comprises:
generating an extended finite automata (XFA) of the new regular expression;
combining the XFA of the new regular expression with an XFA of the regular expression pattern set, yielding an updated XFA; and
compressing the updated XFA, yielding a compressed finite automata (CFA).

8. The method of claim 1, wherein the primary TCAM is a memristor-implemented TCAM.

9. The method of claim 8, wherein the secondary TCAM is a memristor-implemented TCAM.

10. A system comprising:
a primary ternary content-addressable memory (TCAM) programmed with a regular expression pattern set;
a secondary TCAM programmed with a new regular expression to be added to the regular expression pattern set; and
hardware logic to process incoming data strings against the primary TCAM and the secondary TCAM in parallel, while the regular expression pattern set is being updated to add the new regular expression.

11. The system of claim 10, wherein the hardware logic is online hardware logic, and the system further comprises:
offline hardware logic to update the regular expression pattern set to add the new regular expression.

12. The system of claim 10, wherein when the regular expression pattern set has been updated to add the new regular expression, the hardware logic is to temporarily pause processing of the incoming data strings until the primary TCAM has been programmed with the updated regular expression pattern set,
and wherein when the primary TCAM has been updated with the updated regular expression pattern set, the hardware logic is to resume processing of the incoming data strings against just the primary TCAM programmed with the updated regular expression pattern set and not against the secondary TCAM.

13. The system of claim 10, wherein the primary TCAM is a first primary TCAM, the system further comprising:
a second primary TCAM,
wherein when the regular expression pattern set has been updated to add the new regular expression, the second primary TCAM is programmed with the updated regular expression pattern set,
and wherein when the secondary primary TCAM has been programmed with the updated regular expression pattern set, the hardware logic begins processing of the incoming data strings against just the second primary TCAM programmed with the updated regular expression pattern set and not against the first primary TCAM or against the secondary TCAM.

14. The system of claim 10, wherein the input strings are received over a network, and wherein the hardware logic is to, for each input string:
determine that the input string is not a potential network security threat and immediately permit the input string to pass responsive to the input string failing to match both the primary TCAM and the secondary TCAM; and
determine that the input string is a potential network security threat and not immediately permit the input string to pass responsive to the input string matching one or more of the primary TCAM and the secondary TCAM.

15. The system of claim 10, wherein the primary TCAM is a memristor-implemented TCAM.
